(19) United States
(12) Patent Application Publication
(10) Pub. No.: US 2019/0126083 A1
(43) Pub. Date: May 2, 2019

(54) FIRE SUPPRESSION SYSTEMS

(71) Applicant: KATERRA INC., Menlo Park, CA (US)

(72) Inventors: Michael A. ROCK, Gilbert, AZ (US); Theodore J. COLBURN, Oakland, CA (US); Gary FONG, Cupertino, CA (US); Gregory CROSS, Santa Cruz, CA (US); Mark THOMAS, Cupertino, CA (US)

(73) Assignee: KATERRA INC., Menlo Park, CA (US)

(21) Appl. No.: 15/802,381

(22) Filed: Nov. 2, 2017

(51) Int. Cl. A62C 35/68; A62C 35/64

(52) U.S. Cl. CPC A62C 35/68; A62C 99/0072; A62C 35/64

(57) ABSTRACT

Various embodiments relate to fire suppression systems. A fire suppression system may include at least one fire suppression module. The fire suppression module may include a fire suppression system component, an at-pressure connector assembly coupled to the fire suppression system component. The fire suppression system may further include a first conduit having a first end coupled to the fire suppression system component via the at-pressure connector assembly. Further, the fire suppression system may include a second at-pressure connector coupled to a second end of the first conduit.

### FIELD

The embodiments discussed herein relate to fire suppression systems.

### BACKGROUND

Fire suppression systems, which may include wet sprinkler systems or dry sprinkler systems, may be used to limit and/or prevent a fire from spreading (e.g., in a building).

The subject matter claimed herein is not limited to embodiments that solve any disadvantages or that operate only in environments such as those described above. Rather, this background is only provided to illustrate one example technology area where some embodiments described herein may be practiced.

### SUMMARY

One or more embodiments of the present disclosure may include a fire suppression module. The fire suppression module may include a fire suppression system sprinkler housing. Further, the fire suppression module may include an at-pressure connector assembly coupled to the fire suppression system sprinkler housing. The fire suppression module may also include a first conduit having a first end coupled to the fire suppression system sprinkler housing via the at-pressure connector assembly. In addition, the fire suppression module may include a second at-pressure connector coupled to a second end of the first conduit.

Other embodiments may include a fire suppression system configured for modification while being active and having at least one fire suppression module. The fire suppression module may include a fire suppression system component. Further, the fire suppression module may include a first at-pressure connector coupled to the fire suppression system component. The fire suppression module may also include a first conduit having a first end coupled to the fire suppression system component via the first at-pressure connector. In addition, the fire suppression module may include a second at-pressure connector coupled to a second end of the first conduit.

According to other embodiments, the present disclosure includes methods for constructing and/or modifying a fire suppression system. Various embodiments of such a method may include coupling an at-pressure connector to a tributary of a fire suppression system. The method may also include pressurizing the fire suppression system including the tributary. Further, the method may include expanding the fire suppression system via coupling at least one fire suppression system component to the at-pressure connector while the fire suppression system is pressurized.

The object and advantages of the embodiments will be realized and achieved at least by the elements, features, and combinations particularly pointed out in the claims. Both the foregoing general description and the following detailed description are exemplary and explanatory and are not restrictive.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts an example fire suppression system;

FIGS. 2A-2C depict example connection configurations, arranged in accordance with various embodiments of the present disclosure;

FIGS. 3A and 3B depict example hybrid at-pressure connectors, in accordance with at least one embodiment of the present disclosure;

FIG. 4 depicts an example fire suppression system, according to at least one embodiment of the present disclosure;

FIG. 5 illustrates an example fire suppression system including a fire suppression module and various connectors, in accordance with at least one embodiment of the present disclosure;

FIG. 6 illustrates an example fire suppression system including a plurality of fire suppression modules and a plurality of connectors, in accordance with at least one embodiment of the present disclosure;

FIG. 7 illustrates an example fire suppression module, according to at least one embodiment of the present disclosure;

FIG. 8 illustrates another example fire suppression module, in accordance with at least one embodiment of the present disclosure;

FIG. 9 illustrates yet another example fire suppression module, according to at least one embodiment of the present disclosure;

FIG. 10 is a flowchart of an example method of constructing and/or modifying a fire suppression system, in accordance with at least one embodiment of the present disclosure; and

FIG. 11 illustrates a structure including a fire suppression system, according to at least one embodiment of the present disclosure.

### DESCRIPTION OF EMBODIMENTS

Various embodiments disclosed herein relate to fire suppression systems, which may be applicable for both wet and dry fire suppression systems. In some embodiments, a fire suppression system may be modifiable (e.g., via expansion, via repair, etc.) while active (e.g., pressurized). In these and other embodiments, a fire suppression system, which may be installed at, for example, a construction site (e.g., within a structure being built) may be configured to be active during construction (e.g., of a structure). More specifically, for example, a main line and/or one or more tributaries of a fire suppression system may be active during construction. Further, a main line and/or one or more tributaries of the fire suppression system may be active while the fire suppression system (e.g., one or more branches/tributaries of the fire suppression system) are modified (e.g., expanded and/or repaired).

As will be appreciated, structures (e.g., wood-based buildings) under construction may be at risk of fire. For example, for midrise construction (e.g., 4 or more stories), especially in in-fill situations, difficulty obtaining fire services put such structures at risk during construction. The NFPA (National Fire Protection Agency) has reported that in a time period from 2010 to 2014 there were on average 3,750 fires per year in buildings under construction in the United States.

In a construction area, for example, sprinkler heads may be falsely triggered by construction activities. Further, sprinkler piping may be inadvertently cut or damaged during the course of normal construction activities. Accordingly, conventional fire suppression systems are typically constructed floor-by-floor and pressurized after the entire plumbing run has been completed, which is usually after all floors have been completed. Drawbacks are spotty coverage during construction and the need to pressurize and depressurize a fire suppression system.

Further, conventional fire suppression systems may be difficult to service and/or maintain without depressurizing. For example, in some conventional fire suppression systems, if a single sprinkler head is faulty (e.g., leaking), an entire section of the fire suppression system may need to be shutdown (e.g., depressurized) to make repairs. These extra steps are time-consuming, inconvenient, and subject to operator error. For at least these reasons, conventional fire suppression systems are typically installed and activated late in a construction phase. Thus, a structure may be unprotected against fire during the majority of the construction of the structure.

Various embodiments disclosed herein may relate to fire suppression systems configured to be pressurized early in a construction phase. Further, various fire suppression systems, in accordance with various embodiments, may be expandable (e.g., via rigid or non-rigid sections (e.g., tubing, pipes, etc.) and updateable (e.g., repairable) as construction progresses, thus providing continual coverage (e.g., during and after construction) of a structure.

Compared to conventional fire suppression systems, a modifiable, active fire suppression system, according to various embodiments disclosed herein, may significantly reduce the number of fires (e.g., during construction) and/or the extent of damage caused by fires.

Embodiments of the present disclosure are now explained with reference to the accompanying drawings.

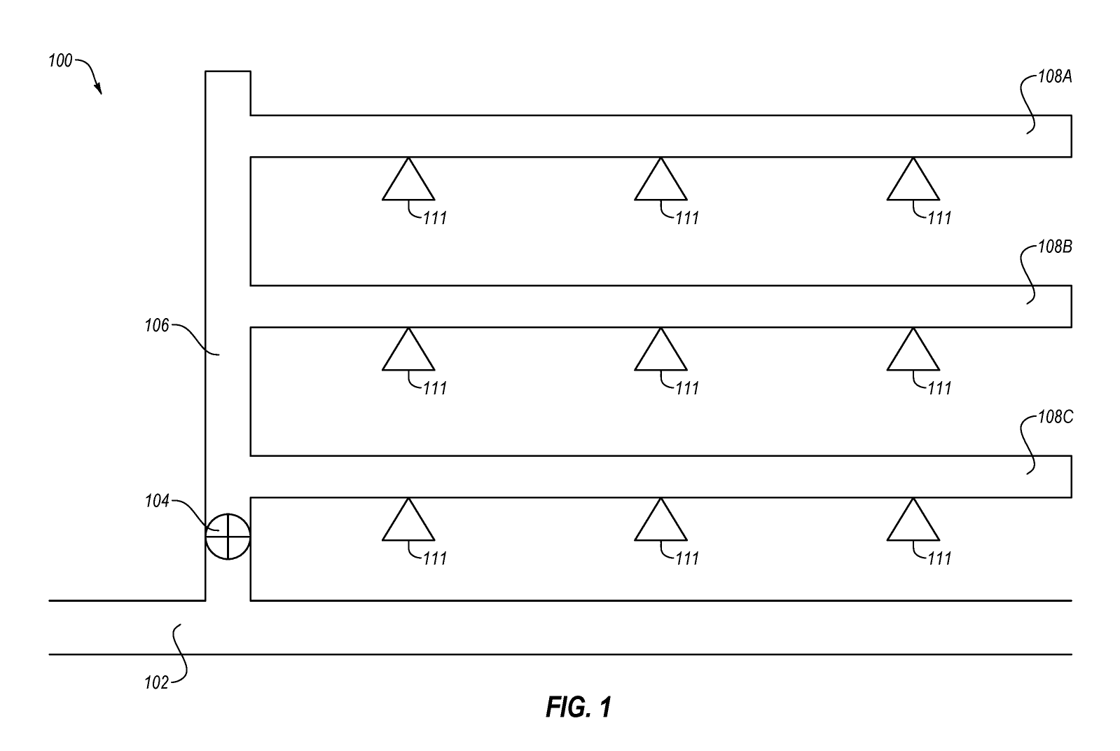

FIG. 1 depicts a fire suppression system 100. System 100 includes a main line 102, a valve 104, and a tributary 106. As depicted in FIG. 1, valve 104 is positioned between main line 102 and tributary 106. System 100 further includes a plurality of branches 108A-108C, wherein each branch 108A-108C is coupled to tributary 106. Each branch 108A-108C may include one or more sprinkler heads 111. In conventional fire suppression systems, valve 104 may remain in a closed position until tributary 106 and each branch 108A-108C have been assembled.

Various embodiments, as disclosed herein, may include a fire suppression system including one or more at-pressure connectors. An “at-pressure” connection (APC), including an at-pressure connector, may allow two devices (e.g., two conduits) at different pressures to connect with little or no leakage (e.g., of fluid). According to various embodiments, an APC connection may provide a seal (e.g., limit or prevent leakage) and control passage of contents (e.g., fluid substances, such as water, sewage, and/or gas) from one component (e.g., one conduit) to another component (e.g., another conduit). In contrast to an unmated connector, which may prevent the flow of contents, a mated connector (e.g., including a female component and a male component) may allow the flow of contents, wherein the flow control may be directional. In some embodiments, a connector (e.g., a male or female connector) may include a valve for preventing leakage while unmated.

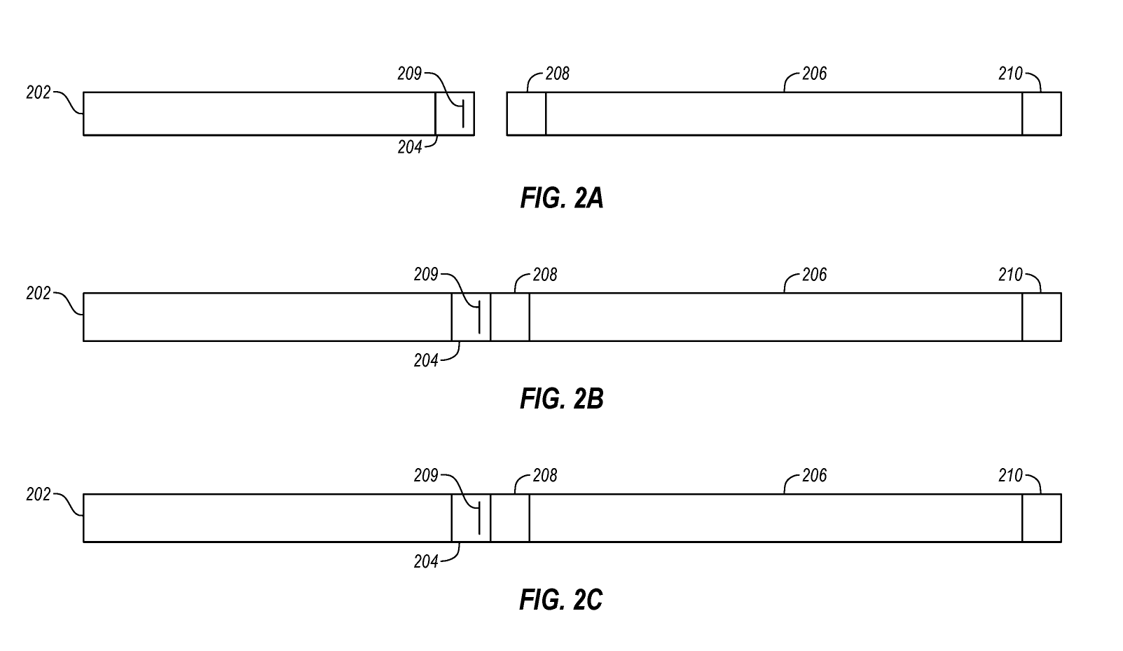

FIGS. 2A-2C depict various example connection configurations including one or more connectors. More specifically, FIG. 2A depicts a conduit 202 coupled to a connector 204, and a conduit 206 coupled to a connector 208 and a connector 210. In this example configuration of FIG. 2A, conduit 202 is not coupled to conduit 206.

In some embodiments, connectors may couple in more than one step. For example, a first step may link the connectors together (e.g., to establish a seal) but may not allow for fluid flow, and a second step, which locks the connectors, may allow for fluid flow. For example, to couple connector 204, which may include a female connector, to connector 208, which may include a male connector, a seal may be established (e.g., during a first step). Further, as connector 208 is progressively engaged to connector 204 (e.g., during a second step), fluid flow may be allowed (e.g., from conduit 202 to conduit 206) and pressure equilibrium may be established between conduit 202 and conduit 206. For example, FIG. 2B depicts connector 204 at least partially coupled to connector 208 (e.g., after completion of a first coupling step). For example, in the configurations shown in FIGS. 2A and 2B, the pressure in conduit 202 may be greater than 1 atmosphere (atm) (e.g., pressure in conduit 202 >>1 atm), and the pressure in conduit 206 may be 1 atm (e.g., pressure in conduit 206 =1 atm).

Further, FIG. 2C depicts connector 204 fully coupled to connector 208 (e.g., after completion of a second coupling step). In the configuration shown in FIG. 2C, the pressure in conduits 202 and 206 may be substantially equal (e.g., pressure in conduit 202 =pressure in conduit 206). As shown in each of FIGS. 2A-2C, connector 204, which, in this example, includes a female connector, includes a venting device 209, as described more fully below.

In some instances of higher pressure (e.g., 100 PSI and above) it may be advantageous to establish a connection slowly (e.g., to prevent a repercussion effect (“hammering”)). For example, in a wet fire suppression system, if the fluid includes water at high pressure, a sudden inrush of the fluid may exert a significant force on the new component (e.g., conduit, sprinkler head, sprinkler housing, etc.) being installed or repaired.

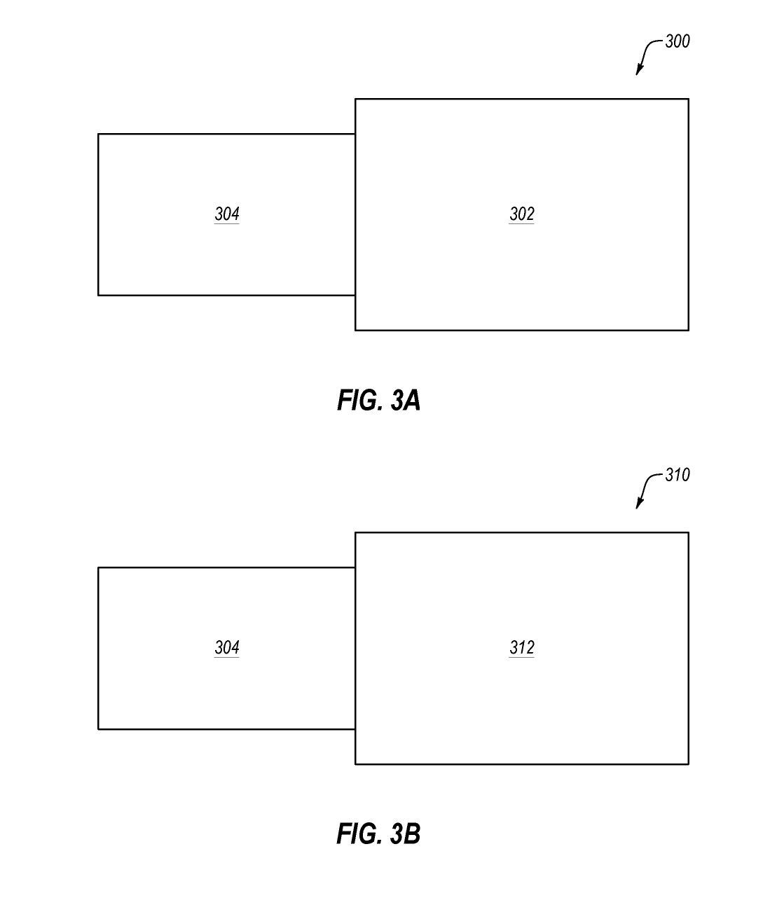

FIG. 3A depicts one example of a hybrid at-pressure connector 300 including an at-pressure connector 302 and a quick connect 304. In this example, at-pressure connector 302 may include a female at-pressure connector, and hybrid at-pressure connector 300 may also be referred to herein as a “hybrid female at-pressure connector” or a “QCAPC-F connector.” In some embodiments, a venting device (not shown if FIG. 3A), as disclosed more fully below, may be positioned adjacent to and/or may be part of (e.g., integrated with) hybrid at-pressure connector 300.

FIG. 3B depicts another example of a hybrid at-pressure connector 310 including an at-pressure connector 312 and quick connect 304. In this example, at-pressure connector 312 may include a male at-pressure connector, and hybrid at-pressure connector 310 may also be referred to herein as a “hybrid male at-pressure connector” or a “QCAPC-M connector.” For example, connector 204 (see FIG. 2) may include hybrid at-pressure connector 300, and connector 208 (see FIG. 2) may include hybrid at-pressure connector 310.

For example, at-pressure connectors 302 and 312 may include “mid-pressure” connectors, which may configured for substantially 40-200 PSI. Further, for example, at-pressure connectors 302 and 312 may comprise an at-pressure connector manufactured by Walther-Prazision™ of Haan, Germany. Moreover, for example, quick connector 304 may include a SharkBite® Push-to-Connect connector manufactured by SharkBite® Plumbing Solutions of Atlanta, Ga.

The term “connector” as used herein may refer to any connector and/or suitable combination of connectors described herein. For example, a “connector” may include an at-pressure connector or a hybrid at-pressure connector. More specifically, for example, a “connector” may include a female at-pressure connector, a male at-pressure connector, a female at-pressure connector and a male at-pressure connector coupled together, a hybrid at-pressure connector (male or female), or a hybrid female at-pressure connector and a hybrid male at-pressure connector coupled together. For example, with reference to FIGS. 2A-2C, a “connector” may include connector 204, connector 208, or connector 204 and connector 208 coupled together.

In addition, the term “connector assembly” may include a female at-pressure connector and a male at-pressure connector coupled together or a hybrid female at-pressure connector and a hybrid male at-pressure connector coupled together.

As noted above, a connector (e.g., a male or female connector) may include a valve for preventing leakage while unmated. Further, in some embodiments, a connector assembly may include two connectors (e.g., a male connector and a female connector), wherein each connector of the connector assembly includes a valve for preventing leakage while unmated. Thus, leakage may be prevented both while a suppression system is being assembled (e.g., expanded) and disassembled.

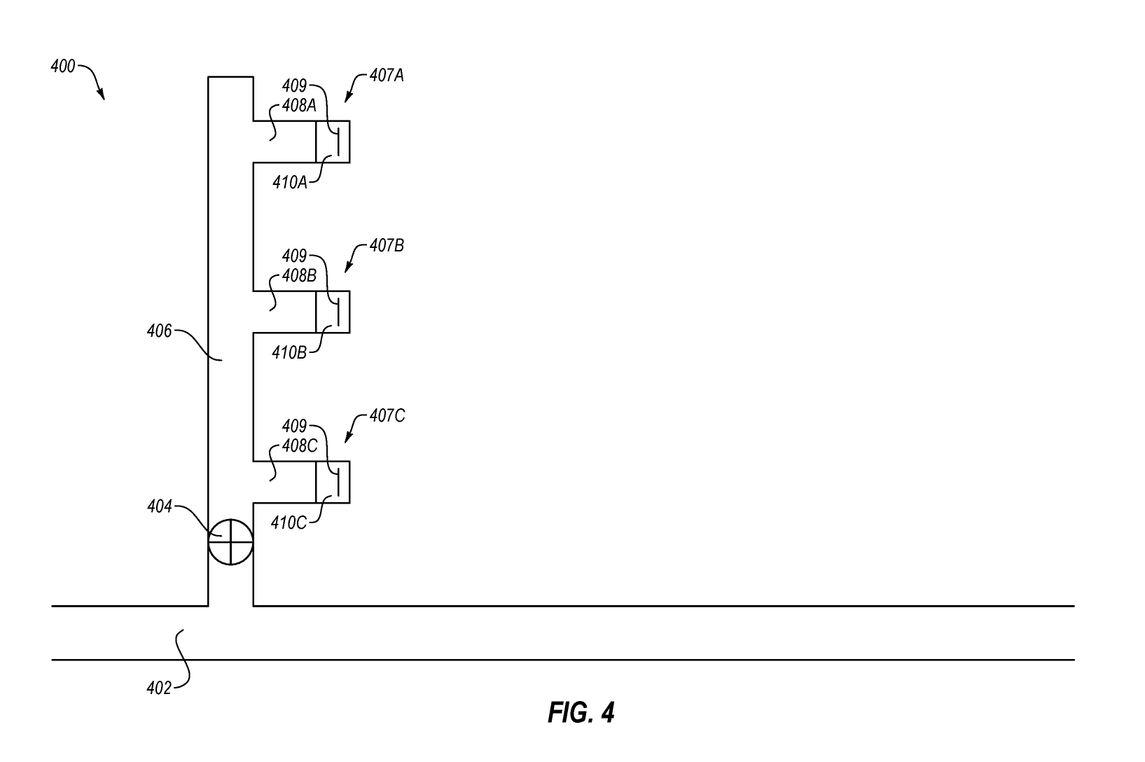

FIG. 4 depicts a fire suppression system 400, according to one or more embodiments of the present disclosure. System 400 includes a main line 402, a valve 404, and a tributary 406. System 400 further includes a plurality of branches 407A-407C. Each branch 407 includes a conduit (e.g., a pipe, a tube, etc.) and may be part of, or may be coupled to, tributary 406. Each branch further includes a connector coupled to an associated conduit. More specifically, branch 407A includes a conduit 408A and a connector 410A, branch 407B includes a conduit 408B and a connector 410B, and branch 407C includes a conduit 408C and a connector 410C.

In at least some embodiments, connectors 410A-410C may each include an at-pressure connector or a hybrid female at-pressure connector. Further, each conduit 408A-408C may include, for example, rigid material (e.g., rigid metallic (e.g., galvanized)) or flexible material (e.g., non-rigid polymeric (e.g. PEX/CPVC)).

According to various embodiments, a fire suppression system, and more specifically, a “wet” fire suppression system may be configured to release air. More specifically, a fire suppression may include a release valve, a venting device, and/or a venting system (e.g., including one or more release valves and/or venting devices), which may be water tight and may be configured to release air at a suitable rate. In some embodiments, one or more venting devices may be configured to release air at a suitable rate such that an air cushion may reduce, and possibly prevent, water hammering upon a section (e.g., a branch (e.g., branch 407A) or a portion of a branch) being installed into a pressurized fire suppression system.

For example, a venting device may include microholes (e.g., non-water permeable microholes) that may be implemented with one or more fire suppression components (e.g., polymeric structures) to provide transparency to visible light whilst preventing water ingress and egress. Further, microholes of a venting device may be sized for pressurized systems (e.g., smaller holes and/or lower density of holes per area).

Alternatively, or additionally, a venting device may include air permeable meshes. In some embodiments, air permeable meshes may be applied in conjunction with microholes to further improve performance of and/or add a layer of security for a venting device. In some embodiments, the venting device may be positioned proximate a female connector.

For example, one or more of connectors 410A-410C may include a venting device 409. Venting device 409 may include, for example, permeable mesh, microholes, a combination thereof, or any other suitable venting device may be configured for releasing air while preventing water ingress/egress. Although venting device 409 is shown adjacent to and/or part of connector 410, the present disclosure is not so limited. Rather, a venting device may be integrated with and/or positioned adjacent to one or more fire suppression components. For example, with reference again to FIGS. 2A-2C, venting device 209 may be positioned in any suitable location (e.g., adjacent to and/or part of (e.g., integrated with) connection 208, adjacent to and/or part of (e.g., integrated with) connection 210, adjacent to and/or part of (e.g., integrated with) conduit 202, or adjacent to and/or part of (e.g., integrated with) conduit 206).

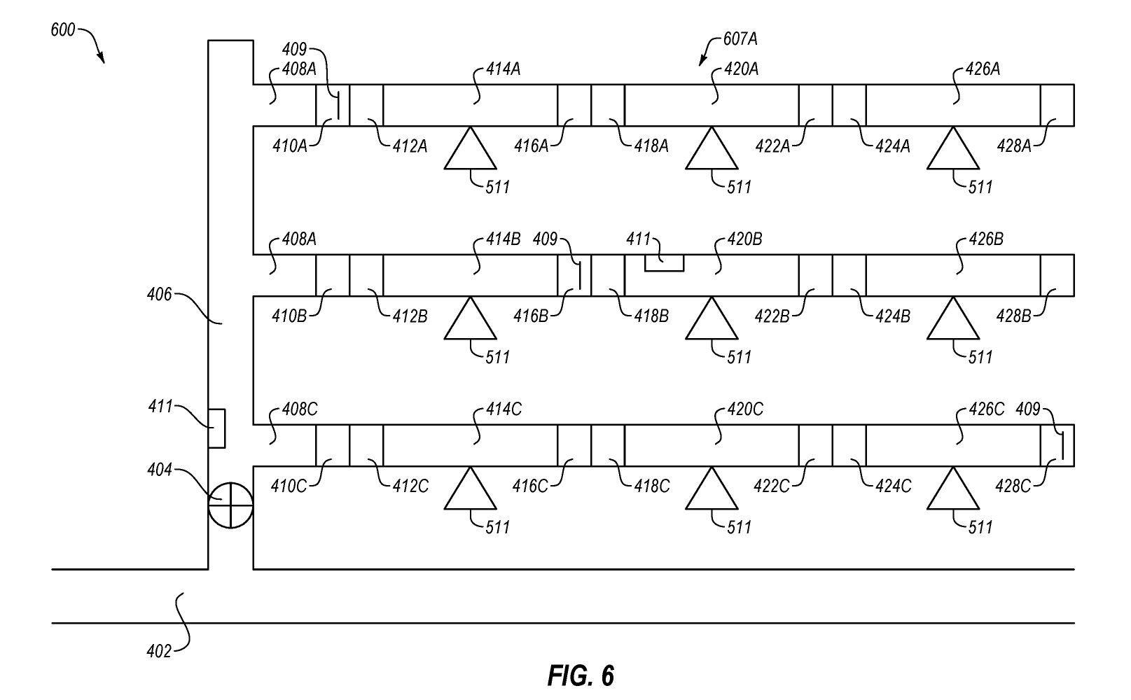

Alternatively, or additionally, various embodiments may include one or more release valves 411 (see FIG. 6). A release valve may be configured to release, for example, air, other gases and/or other extraneous substances, within a fire suppression system. Further, in at least some embodiments, a release valve may be configured to release air while preventing water ingress/egress. According to some embodiments, a release valve may configurable by a user (e.g., property owner, construction worker, maintenance and/or service member, etc.) to release, for example, air. For example, a release valve may include a device (e.g., a shaft, a switch, etc.) selectable and/or adjustable by the user to release air from one or more components (e.g., conduits, sprinkler housings, etc.).

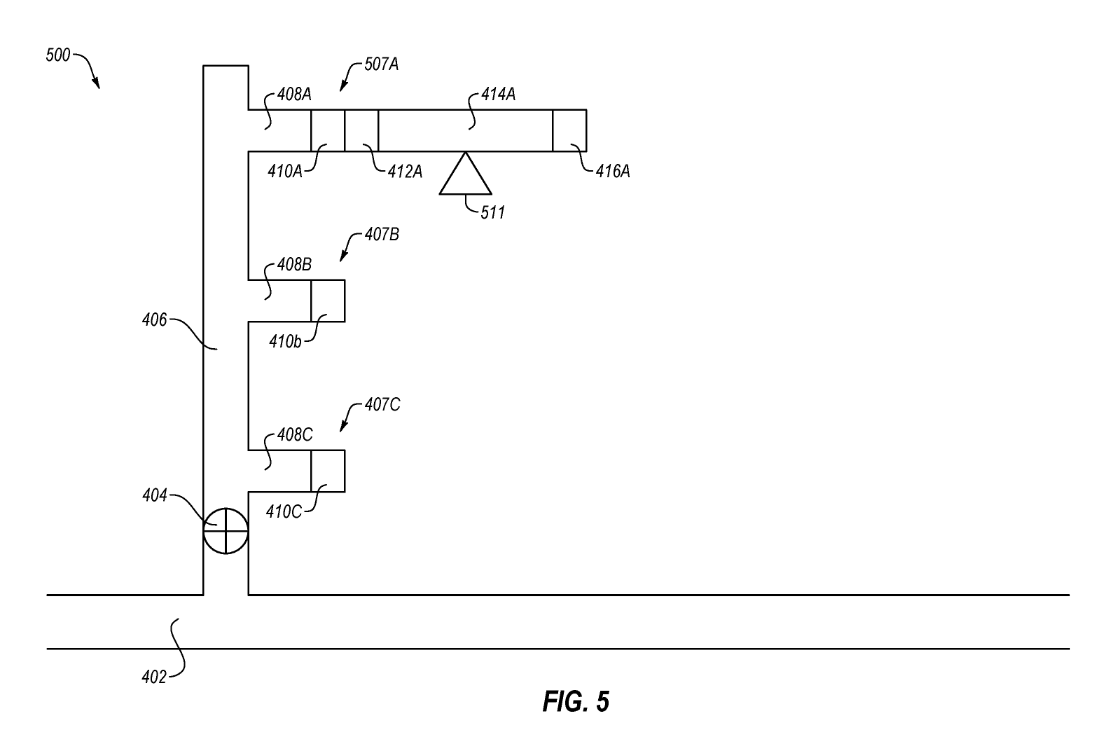

As disclosed herein, various embodiments relate to modification (e.g., expansion, repair, etc.) of an active fire suppression system. For example, FIG. 5 illustrates a fire suppression system 500, according to one or more embodiments of the present disclosure. Fire suppression system 500, which may include fire suppression system 400 shown in FIG. 4, includes main line 402, valve 404, and tributary 406. Further, for example, branch 407A of FIG. 4 has been expanded as branch 507A, which, in addition to conduit 408A and connector 410A, includes connector 412A, module 414A, and connector 416A. In at least some embodiments, connector 416A may include a QCAPC-F connector, and connector 412A may include a QCAPC-M connector. Fire suppression system 500 may further include a sprinkler head 511.

With reference again to FIG. 4, fluid may flow from main line 402 and through conduit 408A. However, connector 410A may prevent additional flow of fluid. Further, with reference to FIG. 5, connectors 412A and 416A may be coupled to module 414A. Thereafter, connector 412A may be coupled to connector 410A. Thus, in the embodiment illustrated in FIG. 5, fluid may flow from main line 402, through conduit 408A, connectors 410A and 412A, and module 414A. However, connector 416A may prevent additional flow of fluid.

As noted above, connectors may be configured to prevent leakage both while a suppression system is being assembled (e.g., expanded) and disassembled. Thus, for example, if connectors 410A and 412A were decoupled, connector 410A may prevent leakage (e.g., from conduit 408A) and connector 412A may prevent leakage (e.g., from conduit 414A).

As another example, FIG. 6 depicts a fire suppression system 600, according to one or more embodiments of the present disclosure. Fire suppression system 600, which may include fire suppression system 500 of FIG. 5, includes main line 402, valve 404, and tributary 406. System 600 further includes a branch 607A, which may be an extension of branch 507A of system 500 (see FIG. 5), a branch 607B, which may be an extension of branch 407B of system 500 (see FIG. 5), and a branch 607C, which may be an extension of branch 407C of system 500 (see FIG. 5).

Branch 607A includes conduit 408A, modules 414A, 420A, and 426A, and connectors 410A, 412A, 416A, 418A, 422A, 424A, and 428A. Branch 607B includes conduit 408B, modules 414B, 420B, and 426B, and connectors 410B, 412B, 416B, 418B, 422B, 424B, and 428B. Further, branch 607C includes conduit 408C, modules 414C, 420C, and 426C and, connectors 410C, 412C, 416C, 418C, 422C, 424C, and 428C. Each module 414, 420, 426 may include, for example module 700, module 800, module 850, or any other suitable module including one or more fire suppression system components.

Further, each of conduits 408A-408C and modules 414A-414C, 420A-420C, and 426A-426C may include, for example, rigid material (e.g., rigid metallic (e.g., galvanized)) or flexible material (e.g., non-rigid polymeric (e.g. PEX/CPVC)). Further, in at least some embodiments, connectors 410A-410C, connectors 416A-416C, connectors 422A-422C, and connectors 428A-428C may include QCAPC-F connectors, and connectors 412A-412C, connectors 418A-418C, and connectors 424A-424C may include QCAPC-M connectors.

In at least some embodiments, fire suppression system 600 may include at least one venting device, which may include a permeable mesh, microholes, a combination thereof, or any other suitable venting device for releasing air from fire suppression system 600 while preventing water ingress/egress. For example, one or more of connectors 410A-410C may include venting device 409. Although fire suppression system 600 is illustrating as having one venting device positioned in each branch 607, the present disclosure is not so limited. Rather, fire suppression system, as disclosed herein, may include any number of venting devices positioned in any suitable location and/or integrated in any suitable manner.

Further, fire suppression system 600 may include at least one release valve 411. A release valve may be positioned in any suitable location and/or integrated in any suitable manner. For example one or more branches 607 may include a release valve and/or tributary 406 may include a release valve.

According to various embodiments, a fire suppression system (e.g., systems 400, 500, and/or 600) may be active (“pressurized”) at any time after a main line and/or one or more tributaries are constructed. Further, the main line (e.g., main line 402) and/or tributaries (e.g., tributary 406, conduits 408, branches 607, etc.) may be pressurized while one or more components (e.g., conduits, modules, sprinkler heads, etc.) of the fire suppression are modified (e.g., extended and/or repaired).

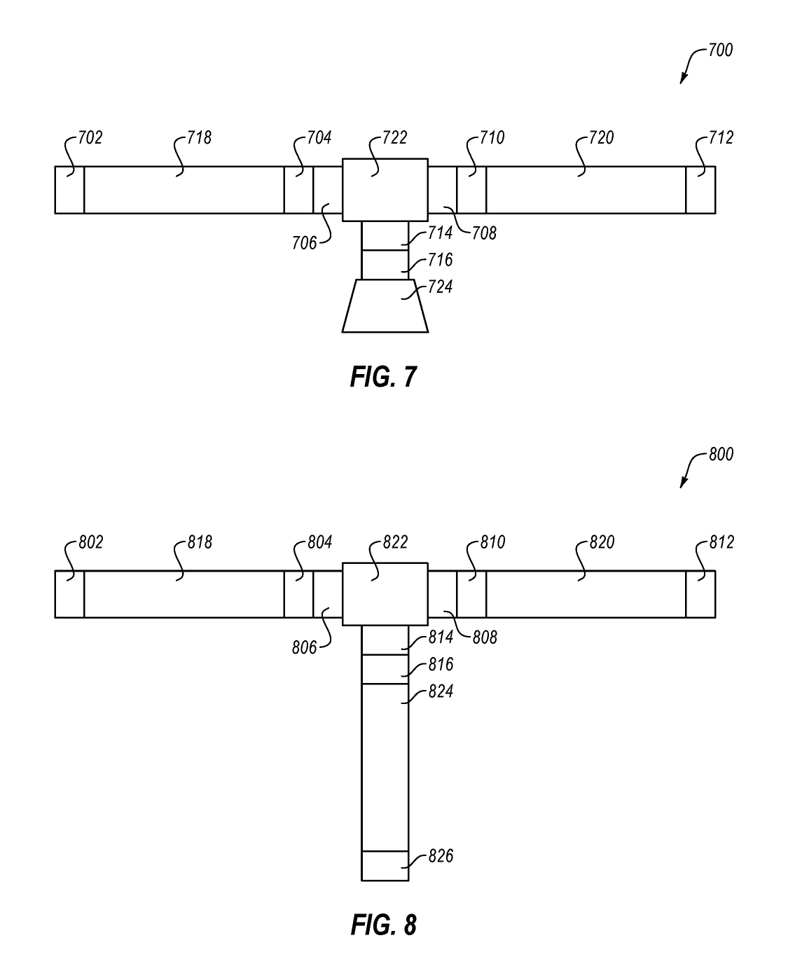

FIG. 7 depicts an example fire suppression module 700, according to at least one embodiment disclosed herein. For example, FIG. 7 may be a side-view of fire suppression module 700. Fire suppression module 700 includes connectors 702, 704, 706, 708, 710, 712, 714, and 716, and conduits 718 and 720, each of which being either rigid or flexible. Fire suppression module 700 also includes sprinkler housing 722 and sprinkler head 724.

A fire suppression module (e.g., module 700) may be implemented in any suitable configuration. As one example configuration, connectors 702, 706, 710, and 716 may include QCAPC-M connectors, and connectors 704, 708, 712, and 714 may include QCAPC-F connectors. As noted above, the term “connector” may refer to any connector and/or any suitable combination of connectors described herein. For example, with reference to FIG. 7, a “connector” may include, for example, connector 704 and connector 706 individually or, for example, connector 704 and connector 706 collectively.

According to some embodiments, a module may include multiple sub-assemblies. For example, with reference to module 700 (see FIG. 7), an assembly may include connector 702, conduit 718, and connector 704. Another assembly may include connectors 706, 708, 714, and 716, sprinkler housing 722 and sprinkler head 724. Further, another assembly may include connectors 710 and 712 and conduit 720. For example, assemblies may be constructed and thereafter coupled together (e.g., to allow fluid flow while preventing fluid from undesirably leaking).

Various embodiments may enable a fire suppression system component (e.g., a connector, a conduit, a sprinkler head, a module, etc.), or a plurality of fire suppression system components, to be added, repaired and/or replaced while the fire suppression system remains active. Further, as noted above, sprinkler heads may be falsely triggered during construction (e.g., due to inadvertent physical contact, heat from a welder's torch, sparks from a saw cutting through metal, etc.). Thus, in at least some embodiments, a sprinkler head (also referred to herein as a “construction sprinkler head” or a “temporary sprinkler head”) that is more robust, less sensitive and/or more protected (e.g., within a cage and/or housing) may be installed and/or used during, for example, a construction phase. Further, another sprinkler head, with normal sensitivity (e.g., to heat) (also referred to herein as a “post-construction sprinkler head” or a “permanent sprinkler head”) may be installed upon completion of the construction phase without shutting down (e.g., depressurizing) a fire suppression system. For example, with reference to FIG. 7, while module 700 is pressurized, sprinkler head 724 may be repaired or removed and replaced with another component, such as another sprinkler head, a conduit, a connector, etc.

In addition, temporary sprinkler heads, which may be removed from a fire suppression system, may be reusable and, therefore, may be used within, for example, another fire suppression system (e.g., at another construction site).

FIG. 8 depicts another example fire suppression module 800, according to at least one embodiment disclosed herein. For example, FIG. 8 may be a top-view of fire suppression module 800. Module 800, which may be a modification (e.g., expansion) of module 700, includes connectors 802, 804, 806, 808, 810, 812, 814, 816, and 826, sprinkler housing 822, and conduits 818, 820, and 824, each of which being either rigid or flexible. For example, module 700 (see FIG. 7) may be modified, while being pressurized, to construct module 800.

As noted herein, FIG. 7 may include a side-view of module 700 and FIG. 8 may include a top-view of module 800. Thus, for example, module 800 may include the components of module 700, and further includes conduit 824, and connectors 814, 816, and 826. In this example, conduit 824, and connectors 814, 816, and 826 are in a plane that is substantially perpendicular to a plane that includes connectors 714 and 716 and sprinkler 724 shown in FIG. 7. Thus, in FIG. 8, connectors 714 and 716 and sprinkler 724 may extend into the page and are obstructed from view by housing 822.

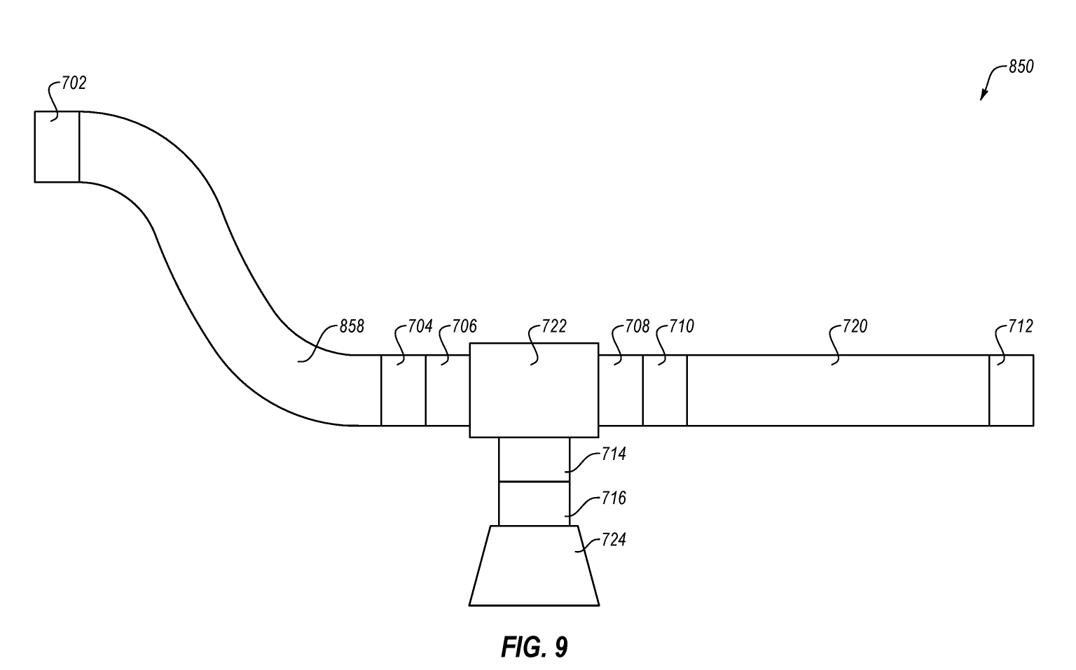

As disclosed herein, various components (e.g., pipes, tubes, etc.) may comprise rigid or flexible material. Utilizing flexible components may enable for components to be routed around physical barriers (e.g., walls, fixtures (e.g., plumbing or lighting fixtures), HVAC components, etc.) and/or allow for components (e.g., tubing, connectors, sprinkler heads, modules) to be positioned in otherwise unavailable locations. For example, as shown in FIG. 9, another fire suppression module 850 includes a flexible conduit (e.g., flexible tubing) 858 for routing around a physical barrier and/or enabling fire suppression module 850 to be positioned in a location that may not otherwise be available without flexible components.

Further, according to various embodiments, one or more fire suppression systems (e.g., system 400, system 500, and system 600) and/or one or more fire suppression modules (e.g., module 700, module 800, and module 850), as described herein, may be integrated in one or more ceiling panels. Deploying a fire suppression module inside a ceiling panel may provide additional protection for the fire suppression module (e.g., from mechanical abuse).

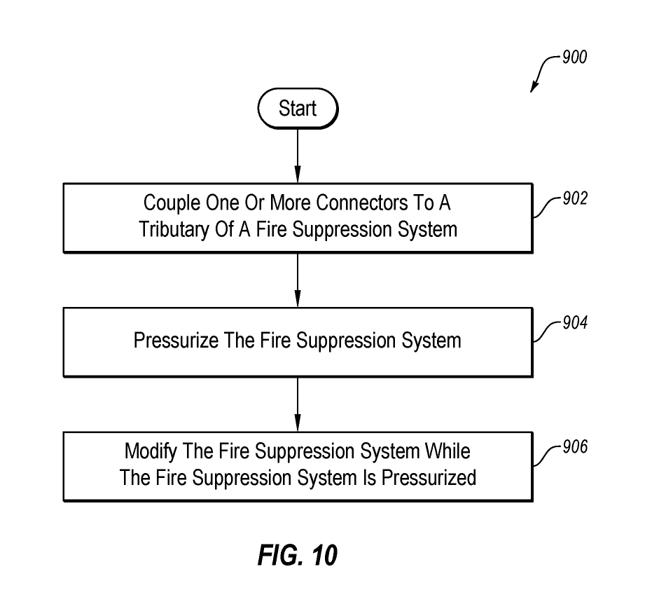

FIG. 10 is a flowchart of an example method 900 of constructing and/or modifying an active fire suppression system, in accordance with at least one embodiment of the present disclosure. At block 902, one or more connectors may be coupled to a tributary of a fire suppression system, and method 900 may proceed to block 904. For example, a first end of a connector (e.g., an at-pressure connector, such as connector 410A of FIG. 4)) may be coupled to a conduit (e.g., conduit 408A of FIG. 4) of a branch (e.g., branch 407A) of a tributary (e.g., tributary 406) of a fire suppression system.

At block 904, the fire suppression system may be pressurized, and method 900 may proceed to block 906. For example, fire suppression system (e.g., fire suppression system 400 of FIG. 4), which may comprise a “wet” or “dry” fire suppression system, may be pressurized via a valve (e.g., valve 404 of FIG. 4).

At block 906, the fire suppression module may be modified while the fire suppression system in pressurized. For example, a fire suppression system component (e.g., a module, a conduit, a sprinkler housing, a sprinkler head) may be coupled to the connector. As a more specific example, fire suppression module (e.g., module 414A of FIG. 5) may be coupled to the connector (e.g., connector 410A of FIG. 5). Yet more specifically, for example, a first end of the module (e.g., module 414A of FIG. 5) may be coupled to a second connector (e.g., hybrid at-pressure connector 412A), and a second end of the module may be coupled to a third connector (e.g., connector 416A of FIG. 5). Further, the second connector (e.g., hybrid at-pressure connector 412A of FIG. 5) may be coupled to the connector (e.g., hybrid at-pressure connector 410A), which is coupled to the tributary (e.g., tributary 406).

Modifications, additions, or omissions may be made to method 900 without departing from the scope of the present disclosure. For example, the operations of method 900 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments.

As an example or more additional fire suppression system components (e.g., modules) may be coupled to fire suppression system. For example, with reference to FIG. 6, module 420A may be coupled to module 414A via connectors 416A and 416B. Further, module 426A may be coupled to module 420A via connectors 422A and 424B. Moreover, additional branches (e.g., branch 607B and/or branch 607C of FIG. 6) of the fire suppression system may be modified. More specifically, with continued reference to FIG. 6, modules 414B, 420B, and 426B may be added to branch 607B and/or modules 414C, 420C, and 426C may be added to branch 607C.

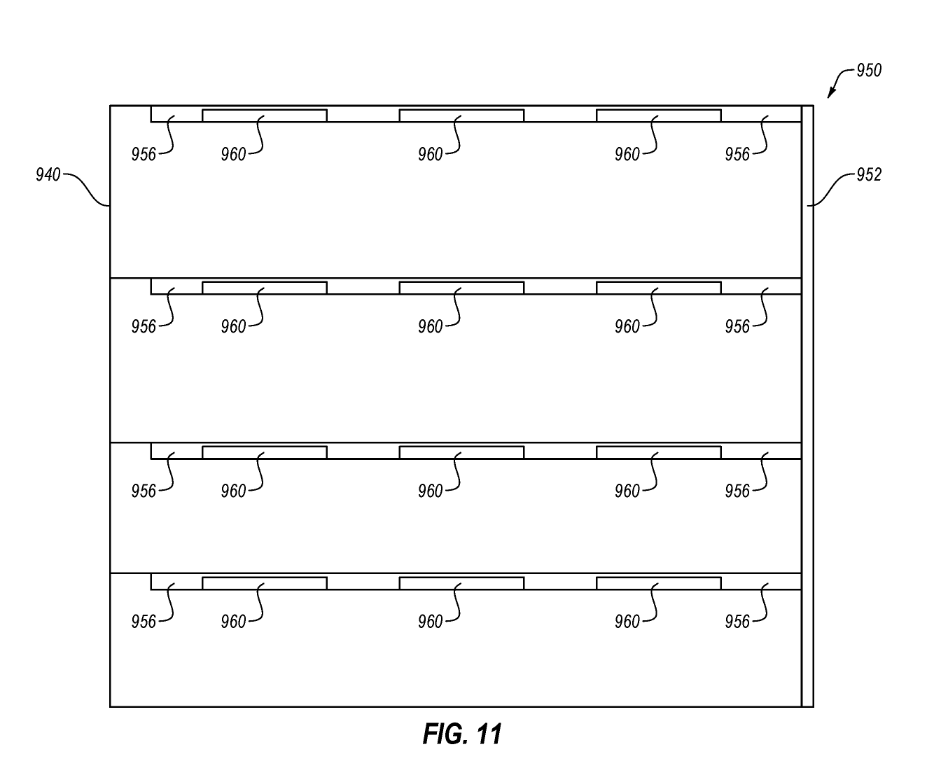

FIG. 11 illustrates a structure 940 including a fire suppression system 950, in accordance with various embodiments of the present disclosure. For example, structure 900 may include a commercial structure (e.g., an office building, a hotel, etc.), a residential structure (e.g., a single-family home, an apartment building, etc.), or any other structure. Fire suppression system 950, which may include, for example, system 400 of FIG. 4, system 500 or FIG. 5, or system 600 of FIG. 6, includes a main line 952 and a plurality of tributaries 956. Further, fire suppression system 950 includes one or more fire suppression system components 960, which may include, for example, conduits, connectors, modules, sprinkler housings, sprinkler heads, etc., or any combination thereof.

According to various embodiments, fire suppression system 950 may be modifiable (e.g., expandable, repairable, etc.) while tributaries 956 are pressurized. As a more specific example, fire suppression system 950 may be expanded (e.g., via adding additional tributaries and/or components (e.g., modules) as structure 900 is under construction. As another example, fire suppression system 950 may be repaired (e.g., via replacing one or more modules and/or components thereof (e.g., a sprinkler head) during construction of structure 900 and/or after completion of structure 940.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

1. A fire suppression module, comprising:
a fire suppression system sprinkler housing;
an at-pressure connector assembly coupled to the fire suppression system sprinkler housing, wherein the at-pressure connector assembly comprises two at-pressure connectors coupled together, wherein each of the two at-pressure connectors each connect components of the fire suppression module at different pressures and prevent flow of contents through the at-pressure connectors while unconnected with little or no leakage during installation or replacement of the components;
a conduit having a first end coupled to the fire suppression system sprinkler housing via the at-pressure connector assembly; and
an other at-pressure connector coupled to a second end of the conduit.

2. The fire suppression module of claim 1, further comprising at least one additional at-pressure connector coupled to the first suppression system sprinkler housing.

3. The fire suppression module of claim 2, wherein the at least one additional at-pressure connector is configured to removably couple to at least one of a different conduit and a sprinkler head.

4. The fire suppression module of claim 3, wherein the sprinkler head comprises one of a temporary sprinkler head and a permanent sprinkler head.

5. The fire suppression module of claim 1, wherein the first conduit comprises one of a flexible material and a rigid material.

6. The fire suppression module of claim 1, wherein the other at-pressure connector includes a quick connector.

7. The fire suppression module of claim 1, further comprising at least one release valve integrated within at least one of the fire suppression system sprinkler housing, the at-pressure connector assembly, the first conduit, and the at-pressure connector.

8. An active, expandable fire suppression system, comprising:
at least one fire suppression module including:
a fire suppression system component;
an at-pressure connector assembly coupled to the fire suppression system component wherein the at-pressure connector assembly comprises two at-pressure connectors coupled together, wherein each of the two at-pressure connectors each connect components of the fire suppression module at different pressures and prevent flow of contents through the at-pressure connectors while unconnected with little or no leakage during installation or replacement of the components;
a conduit having a first end coupled to the fire suppression system component via the at-pressure connector assembly; and
an other at-pressure connector coupled to a second end of the conduit.

9. The fire suppression system of claim 8, further comprising at least one additional at-pressure connector coupled to the fire suppression system component.

10. The fire suppression system of claim 9, wherein the at least one additional at-pressure connector is configured to removably couple to at least one of a different conduit and a sprinkler head.

11. The fire suppression system of claim 10, wherein the sprinkler head comprises one of a temporary sprinkler head and a permanent sprinkler head.

12. The fire suppression system of claim 8, wherein the first conduit comprises one of a flexible material and a rigid material.

13. The fire suppression system of claim 8, wherein the at least one fire suppression module is configured to be positioned within at least one ceiling panel.

14. The fire suppression system of claim 8, wherein the fire suppression system component comprises one of a sprinkler head and a sprinkler housing.

15. The fire suppression system of claim 8, further comprising at least one release valve integrated with at least one fire suppression component and configured to release air from the first suppression system.

16. A method of constructing a fire suppression system, the method comprising:
coupling an at-pressure connector to at least one portion of a manifold of a fire suppression system;
pressurizing the fire suppression system including the manifold; and
after pressurizing the fire suppression system and coupling the at-pressure connector to the fire suppression system, modifying the fire suppression system via coupling at least one conduit or sprinkler housing to the at-pressure connector while the fire suppression system is pressurized.

17. The method of claim 16, wherein coupling the at-pressure connector comprises coupling a hybrid at-pressure connector including a quick connector to the at least one portion of the manifold.

18. (canceled)

19. The method of claim 16, wherein coupling the at least one of the conduit or the sprinkler housing to the at-pressure connector comprises coupling the at least one of the conduit or the sprinkler housing to the at-pressure connector via another at-pressure connector.

20. The method of claim 16, further comprising replacing a fire suppression system component with another a fire suppression system component while the fire suppression system is pressurized.
